(19) United States
(12) Patent Application Publication
(10) Pub. No.: US 2026/0300247 A1
(43) Pub. Date: Oct. 1, 2026

(54) SYSTEM AND METHOD FOR SYNTHETIC QUERY GENERATION AND RETRIEVAL USING A LARGE LANGUAGE MODEL

(71) Applicant: The Toronto-Dominion Bank, Toronto (CA)

(72) Inventors: Stephen ROSE, Toronto (CA); Xueying ZHANG, Toronto (CA); Maksims VOLKOVS, Toronto (CA)

(73) Assignee: The Toronto-Dominion Bank, Toronto (CA)

(21) Appl. No.: 19/636,007

(22) Filed: Apr. 1, 2026

Related U.S. Application Data
(60) Provisional application No. 63/781,673, filed on Apr. 1, 2025.

(51) Int. Cl. G06F 16/22; G06F 16/2457; G06F 18/22

(52) U.S. Cl. CPC G06F 16/2237; G06F 16/24578; G06F 18/22

(57) ABSTRACT

A computer system comprises at least one processor; and a memory coupled to the at least one processor and storing processor-executable instructions which, when executed by the at least one processor, configure the at least one processor to receive a query; embed the query into a query vector; compare the query vector to stored query vectors in a query index to identify at least one similar query; and retrieve at least one document section associated with the at least one similar query.

### CROSS-REFERENCE TO RELATED APPLICATIONS

This application claims the benefit of U.S. Provisional Application No. 63/781,673, filed Apr. 1, 2025, the entire contents of which are incorporated herein by reference.

### TECHNICAL FIELD

The present application relates to systems and methods for synthetic query generation and retrieval using a large language model.

### BACKGROUND

Retrieval systems are difficult to implement, with examples of the difficulty including the trade-off between speed and sorting large amounts of data, as well as the challenge of providing time-sensitive outputs after determining the sorted document or corpus. One example of a retrieval system is a Retrieval-Augmented Generation (RAG) system, which can be based on an artificial intelligence technique that combines two steps: retrieving information from a large collection of documents, referred to as a document corpus, and using that information to generate an accurate response. Instead of relying only on what the model was trained on, RAG searches a document database to find relevant details before generating an answer. This helps reduce errors and allows the model to stay updated without needing constant retraining.

However, digitized retrieval systems, such as RAG systems, require large amounts of computing power. Searching large document sets quickly demands optimized search techniques, while generating responses still relies on heavy artificial intelligence models that need large amounts of capacity provided by rare and expensive Graphics Processing Units (GPUs). As datasets grow larger, these systems become increasingly strained, risking slower outputs, inefficient processing, and higher costs.

Despite improvements in RAG systems, such systems may not guarantee factual accuracy of generated outputs. For example, generative models used in these systems are probabilistic in nature and may produce responses that are fluent but factually incorrect, a phenomenon commonly referred to as hallucination. While retrieval of relevant documents can mitigate this issue, inaccuracies may still arise due to incomplete retrieval, improper ranking of retrieved documents, or misalignment between retrieved content and generated responses.

Increasing the scale and capability of underlying artificial intelligence models may not resolve such inaccuracies. For example, larger models may generate more coherent and contextually plausible responses, but can still produce unverified or incorrect information, particularly when operating on incomplete or ambiguous input data. These inaccuracies can propagate through downstream systems, resulting in repeated retrieval operations, additional token generation cycles, or corrective validation steps that increase processor utilization, memory usage, and latency.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence engine; and

FIG. 4 shows, in flowchart form, an example method for generating synthetic query vectors; and

FIG. 5 shows, in flowchart form, an example method for responding to a query; and

FIG. 6 is a schematic diagram outlining various components of an engine configured to automatically perform document analysis and section identification.

Like reference numerals are used in the drawings to denote like elements and features.

### DETAILED DESCRIPTION OF VARIOUS EMBODIMENTS

Accordingly, in one aspect there is provided a computer system comprising at least one processor; and a memory coupled to the at least one processor and storing processor-executable instructions which, when executed by the at least one processor, configure the at least one processor to retrieve at least one document section from a knowledge base; provide the at least one document section as input to a large language model together with a query that includes a request to generate a predefined number of synthetic queries for the at least one document section; and receive the predefined number of synthetic queries for the at least one document section.

In one or more embodiments the instructions, when executed by the at least one processor, further configure the at least one processor to embed each of the predefined number of synthetic queries into a respective synthetic query vector.

In one or more embodiments the instructions, when executed by the at least one processor, further configure the at least one processor to store each synthetic query vector in association with at least one corresponding document section in a query index.

In one or more embodiments the instructions, when executed by the at least one processor, further configure the at least one processor to embed each document section into a document section vector and store the document section vector in a document section index.

In one or more embodiments the instructions, when executed by the at least one processor, further configure the at least one processor to embed the at least one document section into a document section vector; perform a similarity search using the document section vector against the document section index to detect semantically similar document sections; and in response to detecting the semantically similar document sections, exclude the at least one document section from further synthetic query generations and synthetic query embedding operations.

In one or more embodiments, the query index comprises a vector database configured to store each synthetic query vector as a vector representation, enabling similarity-based searches that, upon receiving a new query, identify stored synthetic query vectors similar to the new query for retrieving associated document sections.

In one or more embodiments, the predefined number of synthetic queries is dynamically adjusted based on a complexity or length of the at least one document section.

In one or more embodiments the instructions, when executed by the at least one processor, further configure the at least one processor to select the at least one document section based on available computing resources including at least one of processor capacity, memory availability, or network bandwidth.

In one or more embodiments the instructions, when executed by the at least one processor, further configure the at least one processor to detect that synthetic queries for the at least one document section have previously been generated; and in response to detecting that synthetic queries have previously been generated, exclude the at least one document section from further synthetic query generation.

In one or more embodiments the instructions, when executed by the at least one processor, further configure the at least one processor to generate the query that includes the request to generate the predefined number of synthetic queries for the at least one document section by assembling the query based on system-defined templates and dynamically selected parameters based on one or more characteristics of the at least one document section.

According to another aspect there is provided a computer-implemented method comprising retrieving at least one document section from a knowledge base; providing the at least one document section as input to a large language model together with a query that includes a request to generate a predefined number of synthetic queries for the at least one document section; and receiving the predefined number of synthetic queries for the at least one document section.

In one or more embodiments, the method further comprises embedding each of the predefined number of synthetic queries into a respective synthetic query vector.

In one or more embodiments, the method further comprises storing each synthetic query vector in association with at least one corresponding document section in a query index.

In one or more embodiments, the method further comprises embedding each document section into a document section vector and storing the document section vector in a document section index.

In one or more embodiments, the method further comprises embedding the at least one document section into a document section vector; performing a similarity search using the document section vector against the document section index to detect semantically similar document sections; and in response to detecting the semantically similar document sections, excluding the at least one document section from further synthetic query generations and synthetic query embedding operations.

In one or more embodiments, the query index comprises a vector database configured to store each synthetic query vector as a vector representation, enabling similarity-based searches that, upon receiving a new query, identify stored synthetic query vectors similar to the new query for retrieving associated document sections.

In one or more embodiments, the predefined number of synthetic queries is dynamically adjusted based on a complexity or length of the at least one document section.

In one or more embodiments, the method further comprises detecting that synthetic queries for the at least one document section have previously been generated; and in response to detecting that synthetic queries have previously been generated, excluding the at least one document section from further synthetic query generation.

In one or more embodiments, the method further comprises generating the query that includes the request to generate the predefined number of synthetic queries for the at least one document section by assembling the query based on system-defined templates and dynamically selected parameters based on one or more characteristics of the at least one document section.

According to another aspect there is provided a non-transitory computer readable storage medium comprising computer-executable instructions which, when executed, configure at least one processor to retrieve at least one document section from a knowledge base; provide the at least one document section as input to a large language model together with a query that includes a request to generate a predefined number of synthetic queries for the at least one document section; and receive the predefined number of synthetic queries for the at least one document section.

According to another aspect there is provided a computer system comprising at least one processor; and a memory coupled to the at least one processor and storing processor-executable instructions which, when executed by the at least one processor, configure the at least one processor to receive a query; embed the query into a query vector; compare the query vector to stored query vectors in a query index to identify at least one similar query; and retrieve at least one document section associated with the at least one similar query.

In one or more embodiments, the stored query vectors include synthetic query vectors.

In one or more embodiments, when comparing the query vector to the stored query vectors in the query index, the instructions, when executed by the at least one processor, further configure the at least one processor to compute a similarity score using cosine similarity or Euclidean distance.

In one or more embodiments the instructions, when executed by the at least one processor, further configure the at least one processor to apply a similarity threshold to filter the stored query vectors in the query index based on the similarity score.

In one or more embodiments the instructions, when executed by the at least one processor, further configure the at least one processor to retrieve a predefined number of top-ranked stored query vectors, each associated with a corresponding document section.

In one or more embodiments, each stored query vector is stored in association with at least one corresponding document section in the query index.

In one or more embodiments the instructions, when executed by the at least one processor, further configure the at least one processor to provide the query and the retrieved at least one document section and as input to a large language model to generate a natural language response to the query.

In one or more embodiments the instructions, when executed by the at least one processor, further configure the at least one processor to output the generated natural language response via a user interface displayed on a computing device.

In one or more embodiments the instructions, when executed by the at least one processor, further configure the at least one processor to select a prompt template based on one or more characteristics of the retrieved at least one document section; and provide the selected prompt template together with the retrieved at least one document section and the query as input to a large language model to generate a natural language response to the query.

In one or more embodiments the instructions, when executed by the at least one processor, further configure the at least one processor to output the generated natural language response via a user interface displayed on a computing device.

According to another aspect there is provided a computer-implemented method comprising receiving a query; embedding the query into a query vector; comparing the query vector to stored query vectors in a query index to identify at least one similar query; and retrieving at least one document section associated with the at least one similar query.

In one or more embodiments, the stored query vectors include synthetic query vectors.

In one or more embodiments, comparing the query vector to the stored query vectors in the query index comprises computing a similarity score using cosine similarity or Euclidean distance.

In one or more embodiments, the method further comprises applying a similarity threshold to filter the stored query vectors in the query index based on similarity score.

In one or more embodiments, the method further comprises retrieving a predefined number of top-ranked stored query vectors, each associated with a corresponding document section.

In one or more embodiments, each stored query vector is stored in association with at least one corresponding document section in the query index.

In one or more embodiments, the method further comprises providing the retrieved at least one document section and the query as input to a large language model to generate a natural language response to the query.

In one or more embodiments, the method further comprises outputting the generated natural language response via a user interface displayed on a computing device.

In one or more embodiments, the method further comprises selecting a prompt template based on one or more characteristics of the retrieved at least one document section; providing the selected prompt template together with the retrieved at least one document section and the query as input to a large language model to generate a natural language response to the query; and outputting the generated natural language response via a user interface displayed on a computing device.

According to another aspect there is provided a non-transitory computer readable storage medium comprising computer-executable instructions which, when executed, configure at least one processor to receive a query; embed the query into a query vector; compare the query vector to stored query vectors in a query index to identify at least one similar query; and retrieve at least one document section associated with the at least one similar query.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

The systems and methods described herein improve upon conventional RAG approaches by shifting from content-based matching to query-based matching. By pre-generating and storing synthetic and historical query vectors linked to document sections, the system better aligns retrieval with user intent, enhances response relevance, and reduces irrelevant matches. The systems and methods described herein lower memory requirements, reduce index size, and enable faster and more efficient search operations by operating over a compact, targeted embedding space.

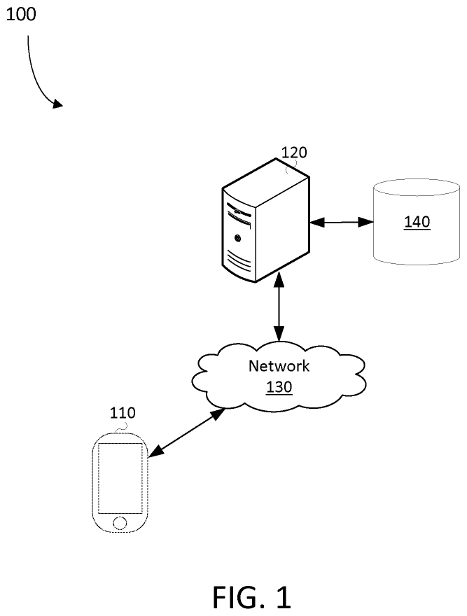

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include or be in communication with a data store 140, such as a memory or other memory store. The data store 140 may store a knowledge base, which may include a corpus of documents divided into retrievable segments or units. These documents may include structured or unstructured data sources, such as manuals, policies, product guides, support articles, or similar informational materials. In at least some implementations, a document may be divided into sections, and synthetic queries may be generated either for the entire document or for at least one section of the document. As used herein, at least one section of a document may refer to any portion, segment, or subdivision of the document, including but not limited to the entire document itself, one or more top-level sections, one or more subsections, individual paragraphs, sentences, table entries, figure captions, or any other logically or structurally identifiable part. This allows the system to finely target portions of the document that are most relevant to user queries.

The data store 140 may additionally or alternatively store a query index, which may include synthetic queries generated by a large language model (LLM), historical or prior user queries, and/or embedded representations of those queries as stored query vectors. The query index maintains links between each stored query or stored query vector and its corresponding document section or sections. Each stored query vector points back to at least one specific document section, such that when a live (incoming) query is embedded and compared against the stored query vectors, the system can retrieve the associated document section or sections. This enables the system to support highly granular retrieval, improving relevance and specificity over prior systems, regardless of whether the stored query vectors originate from synthetic or historical data.

The system may implement an artificial intelligence (AI) engine that integrates the knowledge base and the query index to enhance RAG. Unlike conventional RAG systems that embed a query and search against embedded document content, the present system may retrieve stored queries, including synthetic queries, historical queries, or both, that are associated with specific document sections in the knowledge base. Synthetic queries may anticipate the kinds of real-world questions users may ask, effectively transforming content into a question-like format that is easier to match against incoming user queries.

When the server computer system 120 receives a user query, the system may embed the query into a query vector and compare it to the stored query vectors in the query index, rather than comparing it directly to content vectors. This approach reduces noise and improves retrieval relevance by focusing on query-to-query similarity rather than query-to-content similarity. In some implementations, between 10 and 75 synthetic queries may be generated per document section, allowing for a diverse set of potential matches and creating clustering patterns that surround real-world user questions. This clustering effect increases the likelihood that any user question will closely align with at least one stored query, enhancing retrieval precision.

The server computer system 120 may store synthetic queries in advance by retrieving document sections from the knowledge base, providing them as input to an LLM alongside a request to generate a predefined number of synthetic queries, and receiving those queries for storage. Each synthetic query may be embedded and indexed for later retrieval, enabling the system to conduct similarity searches efficiently at runtime. In one or more embodiments, the query index may additionally or alternatively include historical or prior user queries that have been embedded into stored query vectors, allowing the system to perform similarity comparisons against both synthetic and historical data. This blended approach further improves retrieval accuracy and system robustness by leveraging multiple sources of query representations.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

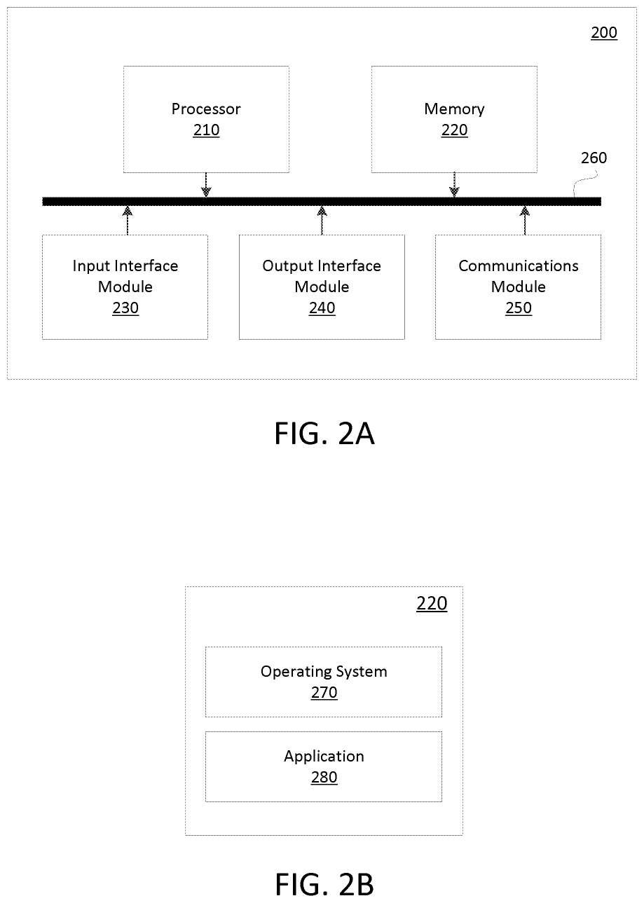

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

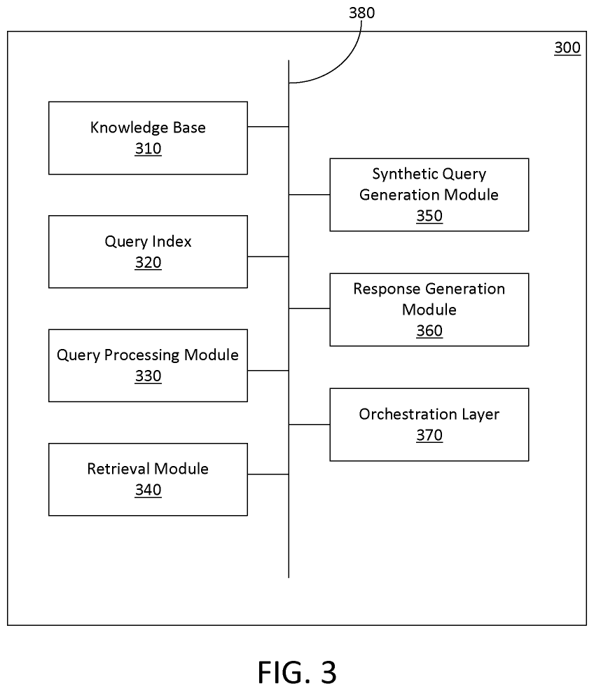

FIG. 3 is an example schematic diagram outlining various components of an engine 300. The engine 300 may be provided by or on the server computer system 120. In at least some implementations, the engine 300 may be distributed across multiple computer systems, which may operate cooperatively. In at least some implementations, one or more of the models or modules that are illustrated as being provided in the engine 300 may, instead, be provided on external systems, including third-party systems.

The engine 300 may also be referred to as an artificial intelligence system. The engine may, in some implementations, operate as a synthetic query generation system and/or a RAG system.

The engine 300 may include one or more modules and/or models. In the illustrated example, the engine 300 includes a knowledge base 310, a query index 320, a query processing module 330, a retrieval module 340, a synthetic query generation module 350, a response generation module 360, and an orchestration layer 370. The various modules and/or models may communicate over a pipeline 380.

The knowledge base 310 may include or may communicate with a data store that holds a document corpus. The document corpus may include structured and unstructured data sources, which provide factual or reference material relevant to user queries. In some implementations, documents may be divided into sections, allowing the system to generate and associate synthetic queries not only with entire documents but also with at least one section of a document. This enhances the granularity of retrieval, enabling the system to target the most relevant sections when answering user queries. As mentioned previously, at least one section of a document may refer to any portion, segment, or subdivision of the document, including but not limited to the entire document itself, one or more top-level sections, one or more subsections, individual paragraphs, sentences, table entries, figure captions, or any other logically or structurally identifiable part.

The query index 320 stores synthetic queries that were generated for specific document sections. In one or more embodiments, the index may additionally or alternatively store historical or prior user queries associated with document sections. These synthetic queries and/or historical queries may be embedded into vector representations, enabling efficient similarity-based search. Each synthetic query or historical query may be linked back to its originating document section, allowing the system to quickly identify relevant content when matching a user query. By structuring the index around synthetic queries and/or historical queries, the system ensures that all stored items resemble the form of user queries, making the retrieval process more precise and intuitive.

The query processing module 330 receives an incoming user query and prepares it for downstream processing. For example, the query processing module 330 may embed the incoming query into a query vector using an embedding model. The query vector may then be passed to the retrieval module 340 for similarity search against the query index 320. In addition to embedding the query, the query processing module 330 may retain the original query and may provide it to the response generation module 360. This allows the system to generate responses that are directly aligned with the specific wording, intent, or nuances of the user's query, rather than relying solely on the retrieved document sections or synthetic queries.

The retrieval module 340 performs a vector similarity search between the embedded query vector and stored query vectors, where the stored query vectors may include stored synthetic query vectors and/or stored historical query vectors. The retrieval module 340 may compute similarity scores using metrics such as cosine similarity or Euclidean distance. Based on the computed similarity scores, the retrieval module 340 may select the most relevant synthetic queries and/or historical queries and, in turn, may identify the associated document sections from the knowledge base. If any one of the synthetic queries or historical queries associated with a document section shows sufficient similarity to the user query, the system may return the corresponding document section to the response generation module 360 for further processing.

In one or more embodiments, the retrieval module 340 may apply a similarity threshold when comparing the query vector to stored query vectors. For example, the system may only consider synthetic queries that have a similarity score above a predefined threshold, such as for example 0.7, to filter out low confidence matches. The predefined threshold may be applied to improve retrieval precision by excluding weak matches and focusing on the most semantically relevant queries.

In one or more embodiments, the retrieval module 340 may also retrieve a predefined number of top-ranked synthetic queries and/or historical queries based on the computed similarity scores. For example, the system may retrieve the top 3 or top 5 highest-scoring synthetic queries and/or historical queries, each linked to its own corresponding document section. By retrieving the predefined number of top-ranked synthetic queries and/or historical queries and their corresponding document sections, the system takes into consideration a representative set of strong matches, improving robustness and the quality of downstream response generation.

The synthetic query generation module 350 is responsible for generating synthetic queries in advance. For each document section in the knowledge base, the module may submit a request to a large language model (LLM), including the section and a predefined number of synthetic queries to generate. The predefined number may include, for example, 10 to 75 synthetic queries. The generated synthetic queries are then embedded and stored in the query index 320 for future retrieval. In parallel or additionally, the system may store embedded historical or prior user queries in the same query index 320, enabling combined retrieval across synthetic and historical data sources. This precomputation ensures that the retrieval index is optimized to mirror the kinds of questions users are likely to ask, improving overall matching performance.

In one or more embodiments, the system may dynamically adjust the predefined number of queries to be generated for a document section based on one or more characteristics of the document section such as for example complexity, length, or content density. For example, a longer or more technical detailed document section may prompt the system to request a larger number of synthetic queries to ensure broad topical coverage, while shorter or simpler sections may require fewer synthetic queries to avoid redundancy. This adaptive query count adjustment helps optimize resource usage, ensures appropriate coverage, and maintains system efficiency.

The response generation module 360 receives one or more retrieved document sections from the retrieval module 340 and the query from the query processing module 330 and passes both to an LLM. The LLM generates a context-aware response using the retrieved information, and this response is provided as output. For example, the response generation module 360 may provide the generated response to the computing device 110, which may involve updating an interface such as a chat interface displayed on the display screen of the computing device 110.

In one or more embodiments, before providing the one or more retrieved document sections and the query to the LLM, the system may dynamically select a prompt template based on one or more characteristics of the one or more retrieved document sections. For example, if a retrieved document section originates from a user manual, the system may apply a prompt template instructing the LLM to provide a clear, step-by-step explanation. For more formal content, such as legal or policy documents, the system may apply a prompt template emphasizing precision and formality. This dynamic selection ensures that the LLM tailors its response style and content generation appropriately for the type of retrieved material.

A representative prompt template may include “You are a helpful technical support assistant. Based on the following section from the user manual, generate a clear, user-friendly answer to the user's question. Section: {document_section} User question: {user_query}.” In this example, the system may dynamically fill in the placeholders with the retrieved document section and the user query, ensuring that the LLM generates a response tailored to the user's content.

Once the LLM generates the natural language response, the system outputs the response via a user interface displayed on a computing device. For example, the system may present the generated response in a chat window, web application, or mobile interface, allowing the user to receive a personalized and contextually accurate answer to their original query.

The orchestration layer 370 coordinates the operations of the various modules, ensuring that synthetic queries and, in some implementations, historical queries are generated, embedded, and indexed, and that incoming user queries are efficiently matched to the stored synthetic queries and/or historical queries. The orchestration layer 370 further manages the flow of information to the response generation module 360, ensuring the system produces a coherent, contextually aware output based on the retrieved content and original user query. By leveraging synthetic queries and historical queries, the system enhances retrieval precision, reduces noise, and improves the alignment between user intent and document section selection.

The orchestration layer 370 may further select which document sections to process for synthetic query generation based on available computing resources, such as processor capacity, memory availability, or network bandwidth. For example, if system load is high or certain resources are constrained, the orchestration layer may prioritize high-impact or high-priority document sections and defer lower-priority sections until resources are available. This resource-aware selection process improves system scalability and avoids overloading computing infrastructure.

By combining synthetic query generation, embedded synthetic query storage, historical query storage, LLM-based response generation, and an orchestrated retrieval mechanism, the engine 300 delivers more accurate and contextually appropriate responses. The system improves efficiency by precomputing relevant synthetic queries and embedding them and by leveraging embedded historical queries, which reduces computational overhead at runtime and strengthens the alignment between user queries and retrieved document sections. In particular, improved alignment between user queries and retrieved document sections reduces the likelihood of generating unsupported or hallucinatory responses, thereby avoiding repeated retrieval operations, additional token generation cycles, and associated processor and memory utilization. This enables flexible retrieval across both full documents and document subsections, allowing the system to scale across different types of corpora, such as internal policy documents or customer data, as needed.

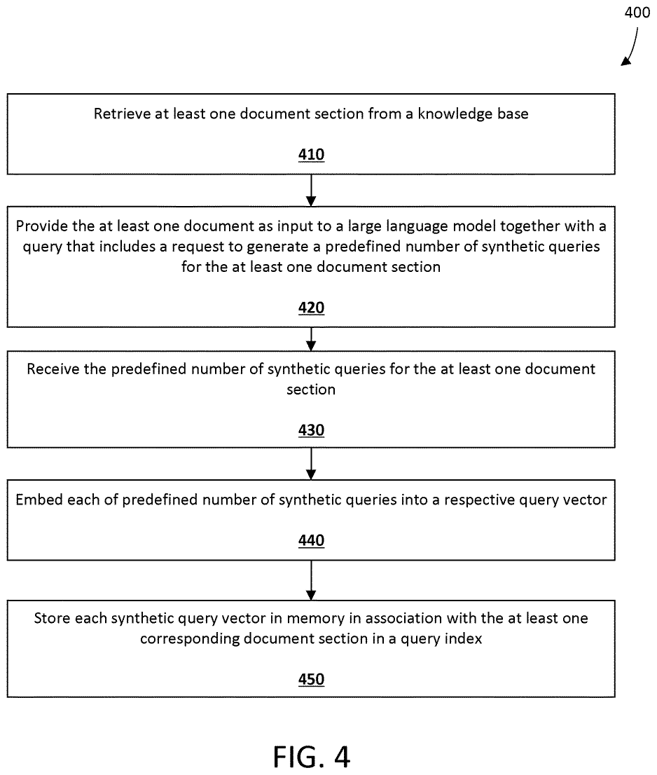

Reference is now made to FIG. 4, which illustrates an example method 400 of generating synthetic query vectors. The method 400 may, in at least some implementations, be performed by one or both of a processor and a computer system. For example, instructions stored in a memory may, when executed, configure the at least one processor and/or computer system to perform all or part of the method 400. At least some of the operations may be performed by one or more modules of the engine 300 described herein.

The method 400 includes retrieving at least one document section from a knowledge base (step 410).

As mentioned, the knowledge base may include or may communicate with the data store 140. The data store 140 may include a document corpus comprising a set of documents. Each document may be structured into multiple sections, subsections, paragraphs, or other logical parts, each representing a discrete retrievable unit.

The documents may originate from various structured or unstructured sources such as for example technical manuals, policy documents, product specifications, support knowledge articles, frequently asked questions (FAQs), internal compliance guidelines, or regulatory bulletins. The system may accommodate documents stored in diverse electronic formats such as for example plain text, Extensible Markup Language (XML), JavaScript Object Notation (JSON), Hypertext Markup Language (HTML), Portable Document Format (PDF), or other formats and may use format-specific parsers to extract content into a normalized internal representation.

The system retrieves at least one document section from the knowledge base. The at least one document section may include a single document section or multiple document sections. As mentioned, a document section may refer to any portion, segment, or subdivision of the document, including but not limited to the entire document itself, one or more top-level sections, one or more subsections, individual paragraphs, sentences, table entries, figure captions, or any other logically or structurally identifiable part. The system may maintain an index mapping content features, metadata, or identifiers to document sections to facilitate efficient retrieval.

In one or more embodiments, the system may iteratively process the entire document corpus, systematically retrieving and processing each available document section. For example, the system may loop over a list of section identifiers, access corresponding storage locations, and read section content into memory.

In one or more embodiments, the system may retrieve only a specified subset of document sections based on an input list of section identifiers or metadata tags. The input list may be provided, for example, by a configuration file.

In one or more embodiments, upon ingestion of a new or updated document in the knowledge base, the system may automatically parse the document into discrete document sections. For example, the system may engage a parser module that relies on structural cues (such as headings, table structures, etc.) or may apply machine learning models trained to detect logical section boundaries. This parsing enables the system to register each section as a distinct retrievable unit within the knowledge base.

During retrieval operations, the system can efficiently determine not only which documents are relevant to a given query or task, but also which specific sections or subsections within those documents are most pertinent. By maintaining section-level granularity and indexing, the system enhances retrieval precision and enables targeted downstream processing in subsequent steps.

The method 400 includes providing the at least one document section as input to a large language model together with a query that includes a request to generate a predefined number of synthetic queries for the at least one document section (step 420).

The LLM may include a transformer-based language model, such as for example ChatGPT, or another large-scale pre-trained model capable of generating coherent, human-like text outputs.

In one or more embodiments, the system provides the at least one document section to the LLM along with a prompt specifying a predefined number of synthetic queries. For example, the prompt may state: “Please generate between 10 and 75 possible user questions about this section that cover its most important content and anticipated inquiries.” For smaller sections, the system may issue more targeted prompts such as for example: “Please generate 10 questions for this paragraph” or “Please generate 5 representative queries for this subsection.” This allows the system to ensure broad and detailed coverage across entire documents and specific document sections.

In one or more embodiments, the system may generate the prompt dynamically, assembling it from system-defined templates and dynamically selected parameters based on one or more characteristics of the document section. For example, the system may apply a prompt template that instructs the LLM to generate user-like queries, adjust one or more parameters of the prompt template based on section type or complexity, or include additional context to guide the LLM's output. This structured prompt-generation process improves consistency, relevance, and efficiency of the synthetic queries.

As one example, a system-defined template may take the form: “Please generate {N} synthetic user questions that reflect typical queries about the following document section: {section_content}.” Here, {N} may be determined dynamically based on one or more characteristics of the document section, such as length, topic complexity, or prior query density. For shorter, straightforward document sections, the system may set {N} to 10, whereas for longer, multi-topic sections, the system may set {N} to 50 or more. The system may embed section-specific metadata or context cues in the prompt, such as the document type (e.g. policy, technical manual, FAQ) or intended audience, to guide the LLM's response. This dynamic prompt assembly ensures that the LLM receives clear, targeted instructions aligned with the nature of each document section, improving the quality and relevance of the generated synthetic queries.

In one or more embodiments, the prompt may specify the desired style of the synthetic queries. For example, the prompt may include: “Generate concise, realistic user questions similar to those asked in a customer support chat.”

In response, the LLM may generate the requested number of synthetic queries.

In one or more embodiments, before generating synthetic queries for a particular document section, the system may check whether synthetic or historical queries already exist for that particular document section. For example, the system may reference a document section identifier, timestamp, or related metadata to determine whether queries are already present in the query index. If prior queries exist, the system may skip query generation and embedding for the particular document section, improving system efficiency by avoiding redundant computation and storage.

The method 400 includes receiving the predefined number of synthetic queries for the at least one document section (step 430).

The LLM returns the requested synthetic queries for the at least one document section. The synthetic queries may be captured as plain text strings. The queries may reflect natural, user-like phrasing such as: “How can I reset my password?”, “What is the company's refund policy?”, or “Where do I find the safety compliance certificate for this product?” Each synthetic query is associated with or explicitly linked to its corresponding document section, ensuring that during retrieval, the system can accurately point to the most relevant content.

The method 400 includes converting the predefined number of synthetic queries for the at least one document section into synthetic query vectors (step 440).

The synthetic queries are transformed into vector representations (embeddings). In one or more embodiments, an embedding model such as Bidirectional Encoder Representations from Transformers (BERT) may be used to map each synthetic query into a high-dimensional numerical vector. In one or more embodiments, the embedding dimensionality may be, for example, 384, 512, or 768 dimensions and this may be dependent on the embedding model used. Each synthetic query vector captures the semantic meaning of the query in a machine-computable format, enabling fast similarity search during retrieval operations. Additional processing steps such as tokenization, vector normalization, or post-processing may optionally be applied to optimize performance or storage.

The method 400 includes storing the synthetic query vectors in memory in association with the at least one document section (step 450).

The synthetic query vectors are stored in a memory structure such as for example a query index designed to support similarity-based search operations. The query index may include or comprise a vector database configured to store each synthetic query vector as a vector representation, enabling similarity-based searches that, upon receiving a new query, identify stored synthetic query vectors similar to the new query for retrieving associated document sections.

Within the query index, each synthetic query vector may be linked to a reference identifier for its associated document section. For example, the system may maintain mappings between each vector identifier, its vector representation, the corresponding document section, and related metadata. This configuration allows the system, upon receiving a new query, to perform similarity searches against the stored synthetic query vectors, identify the most similar vectors, and retrieve the associated document sections, as will be described. In this manner, the system is able to surface the most relevant and focused content efficiently.

In one or more embodiments, the system may additionally generate embeddings for each document section and store these document section vectors in a separate document section index. For example, the system may apply a section-level embedding model to generate a numerical vector representing the semantic content of the document section as a whole. These document section vectors are then stored in a document section index, enabling similarity-based searches between document sections. By maintaining both synthetic query vectors and document section vectors, the system enhances its ability to perform cross-comparisons and efficiently organize the knowledge base.

In one or more embodiments, before generating synthetic queries for a given document section, the system may first embed the document section into a document section vector and may perform a similarity search against the existing document section index. The similarity search may use metrics such as cosine similarity or Euclidean distance to detect whether semantically similar document sections have already been processed. If semantically similar document sections are identified, for example based on a similarity score threshold, the system may exclude the current document section from further synthetic query generation and embedding operations. This deduplication mechanism improves system efficiency by preventing redundant processing of similar content across the knowledge base.

In accordance with the method 400, the synthetic query vectors are pre-generated and stored in memory such that they are readily available for use in a RAG system. Additionally, in one or more embodiments, the system may additionally store embedding of historical or prior user queries alongside the synthetic query vectors in the query index, enabling the retrieval system to operate over both synthetic and historical data sources.

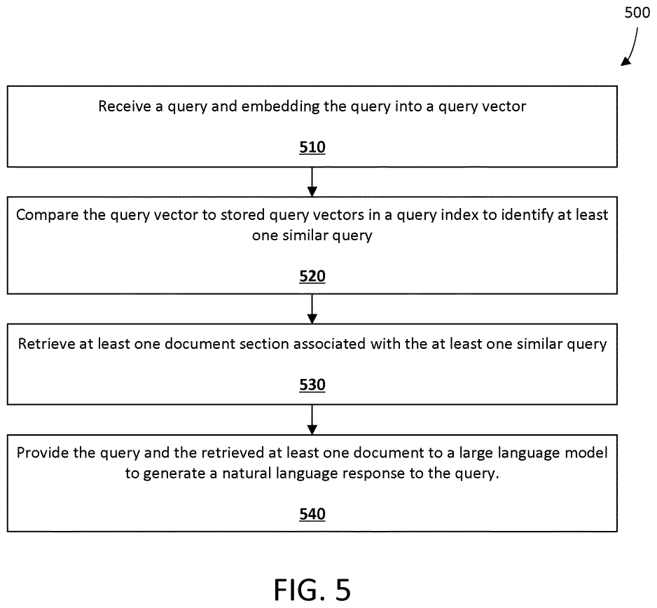

Reference is now made to FIG. 5, which illustrates an example method 500 of responding to a query. The method 500 may, in at least some implementations, be performed by one or both of a processor and a computer system. For example, instructions stored in a memory may, when executed, configure one or both of the processor and the computer system to perform the method 500 or a portion thereof. At least some of the operations may be performed by the engine 300 described herein. For example, at least some of the operations of the method 500 may be performed by the query processing module 330, retrieval module 340 and/or the response generation module 360.

The method 500 includes receiving a query and embedding the query into a query vector (step 510).

A user query is received, for example, via a chat interface, a web form, a voice assistant, or a messaging application programming interface (API). The query may include natural language text such as “Can I get a copy of the 2025 tax policy update?” or “What steps do I follow to set up two-factor authentication on my account?” The query may be preprocessed (e.g., normalized, lowercased, stripped of punctuation) and then converted into a query vector using the same embedding model used during query index generation. This ensures that the user query and the stored query vectors in the query index are represented in the same vector space, enabling accurate similarity comparison.

The method 500 includes comparing the query vector to stored query vectors to identify at least one similar query (step 520).

The query vector is compared against the stored query vectors, which may include synthetic query vectors and/or historical query vectors, using a similarity metric such as cosine similarity or Euclidean distance. For example, if cosine similarity is used, the system may compute similarity scores for the query vector against all stored synthetic query vectors and retrieve the top N most similar vectors. The top N most similar vectors may include, for example, the top 1, top 3, or top 5 most similar vectors. In some implementations, the system may apply a similarity threshold (e.g., 0.7) to filter out low confidence matches. The system may also support weighted similarity or ensemble scoring, combining multiple distance metrics for enhanced matching accuracy.

In one or more embodiments, the at least one closest similar query may include a predefined number of closest stored queries such as, for example, the 3 closest stored queries.

The method 500 includes retrieving at least one document section associated with the at least one closest similar query (step 530).

The system uses the vector-to-document-section mapping to identify the original content associated with each closest stored query. For example, if the top match corresponds to a document section labeled “Section 2.3 of Document ABC,” the system retrieves that document section from the knowledge base. If multiple stored queries point to the same document section, the system may aggregate their scores or consolidate the retrieval result. In some implementations, the system may also retrieve supporting metadata, such as the publication date, author, or confidence score, to enrich the response.

The method 500 includes providing the query and the retrieved at least one document section to a large language model to generate a natural language response to the query (step 540).

Both the query and the retrieved at least one document section are passed to the LLM. In one or more embodiments, the system may construct a prompt including the user query, the retrieved at least one document section, and contextual instructions (e.g., “Answer as a helpful support assistant; if uncertain, say you don't know.”). Once received, the LLM may generate a natural-language response, grounded in content from the retrieved at least one document section but tailored to the specific query. This step may enable the system to deliver contextually accurate, personalized, and up-to-date answers.

In one or more embodiments, the system may dynamically select a prompt template to apply when constructing the input to the LLM, based on one or more characteristics of the retrieved document section. For example, for technical documentation, the system may apply a prompt template designed to elicit precise, instructions answers, whereas for marketing content, the system may apply a prompt encouraging a more conversational and engaging tone. An example prompt template may include: “You are a knowledgeable assistant. Given the following retrieved content, answer the user's question in clear and friendly language. Retrieved content {document_section} User question: {user_query}.” The system may dynamically fill in the placeholders with the appropriate content and query, ensuring that the LLM receives consistent, structured instructions. By dynamically selecting prompts and parameters, the system improves the relevant, clarity, and tone of the generated responses.

After the LLM generates the response, the system outputs the final natural language response to the user via an appropriate user interface. For example, the response may be displayed in a chat interface, web application, or voice assistant output, ensuring that the user receives the generated answer in a clear and accessible format.

In embodiments described herein, by creating and/or incorporating historical queries alongside synthetic queries based on document sections in the knowledge base and storing corresponding stored query vectors, the system enables faster, more efficient retrieval while reducing noise. For example, the engine only needs to embed a new query once, compare it against pre-generated query vectors, and directly retrieve the best-matching document section without re-embedding the entire corpus. This significantly improves system throughput, scalability, and retrieval relevance.

In embodiments described herein where synthetic queries are generated for multiple document sections with a single document, the synthetic queries may be received, converted to synthetic query vectors, and stored in memory in association with the section of the document (rather than the entire document). This enables highly targeted retrieval and response generation, allowing the system to surface the most relevant and focused information aligned to the user's specific query.

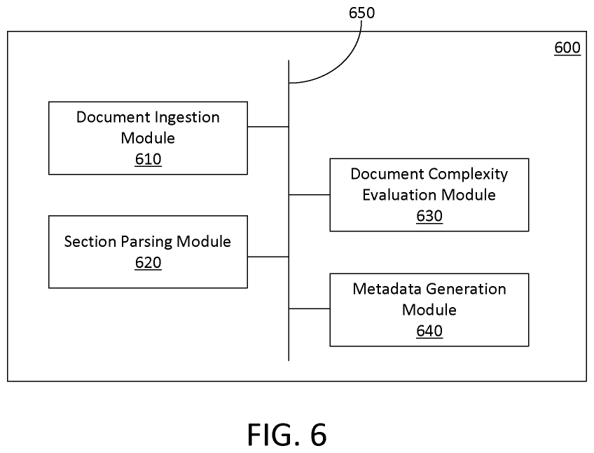

As mentioned, the system may automatically parse one or more documents into discrete document sections and this may be done using a parser module or one or more machine learning modules. FIG. 6 is an example schematic diagram outlining various components of an engine 600 configured to automatically perform document analysis and section identification. The engine 600 may be provided by or on the server computer system 120. In at least some implementations, the engine 600 may be distributed across multiple computer systems that operate cooperatively. In at least some implementations, one or more of the modules or models described herein may alternatively be provided on external systems, including third-party systems.

The engine 600 may include one or more specialized modules for document analysis and section identification. In the illustrated example, the engine 600 includes a document ingestion module 610, a section parsing module 620, a document complexity evaluation module 630, and a metadata generation module 640. The various modules may communicate over a pipeline 650.

The document ingestion module 610 receives incoming documents for analysis. These documents may include structured or unstructured content, such as technical manuals, policy documents, FAQs, product guides, regulatory materials, or internal knowledge articles. The document ingestion module 610 may apply format-specific parsers or adapters to extract raw text and associated metadata, converting the content into a normalized internal representation suitable for downstream processing.

The section parsing module 620 processes the normalized document content to identify discrete sections or subsections. The module may use structural cues, such as heading hierarchies, markup tags, bullet points, or table structures, to delineate logical boundaries within the document. In one or more embodiments, the section parsing module 620 may apply machine learning models trained to detect section boundaries even in unstructured text, enabling the system to handle diverse document types and formats. Each identified section is registered as an independent retrievable unit, with its own section identifier, text content, and associated metadata.

The document complexity evaluation module 630 analyzes each document or document section to estimate one or more characteristics such as length, topic complexity, content density, or estimated reading difficulty. For example, the module may compute quantitative metrics such as word count, sentence complexity scores or keyword density. In one or more embodiments, the module may apply machine learning models trained to classify sections by complexity level or topic granularity. These evaluations may inform subsequent system behavior, such as determining how many synthetic queries to generate or how to prioritize processing workloads.

The metadata generation module 640 compiles the outputs from the section parsing module 620 and the document complexity evaluation module 630, assembling structured metadata records for each section. The metadata may include, for example, section identifiers, document identifiers, section titles or headings, length metrics, complexity scores, and inferred document type or audience category. This metadata may be stored alongside the document corpus in the knowledge base or may be made available to other system components, such as synthetic query generation modules or orchestration layers, to guide further processing.

By combining document ingestion, section parsing, complexity evaluation, and metadata generation, the engine 600 may improve the system's ability to understand and structure incoming documents at a fine-grained level. This enables more precise control over downstream processes, such as dynamic prompt assembly, synthetic query generation, or retrieval prioritization. For example, the system may determine that a short, straightforward section requires only 10 synthetic queries, whereas a long, multi-topic section requires 50 or more synthetic queries to ensure broad topical coverage. By embedding section-specific metadata, the system can tailor its subsequent interactions based on the content, complexity, and characteristics of each document section.

Systems and methods described herein provide numerous technical advantages over conventional RAG systems. Unlike prior systems that rely solely on content embeddings or similarity matching between user queries and document content, the systems and methods described herein pre-generate and store query vectors linked to document sections. This shifts the retrieval paradigm from content-based to query-based matching, improving alignment between user intent and retrieved materials. By embedding and indexing synthetic queries that anticipate user needs, and by leveraging historical queries, the system enhances retrieval precision, reduces irrelevant or noisy matches, and improves response relevance. Additionally, generating and storing synthetic query vectors, rather than document vectors, reduces memory requirements, improves computational efficiency, and enables faster search and retrieval operations, as the system operates over a smaller and more targeted embedding space.

The systems and methods described herein enable highly granular retrieval by associating stored queries not only with entire documents but also with specific document sections, subsections, or paragraphs. This fine-grained mapping allows the system to surface the most targeted and contextually appropriate content in response to a user query, improving both system performance and user experience. Additionally, the systems and methods described herein reduce computational load during query time because stored query embeddings are precomputed and stored, avoiding the need to re-embed the entire corpus on demand. As a result, the system achieves improvements in processing efficiency, scalability, and overall system responsiveness, representing a technical improvement over traditional RAG or vector search systems.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor; and
a memory coupled to the at least one processor and storing processor-executable instructions which, when executed by the at least one processor, configure the at least one processor to:
receive a query;
embed the query into a query vector;
compare the query vector to stored query vectors in a query index to identify at least one similar query; and
retrieve at least one document section associated with the at least one similar query.

2. The computer system of claim 1, wherein the stored query vectors include synthetic query vectors.

3. The computer system of claim 1, wherein when comparing the query vector to the stored query vectors in the query index, the instructions, when executed by the at least one processor, further configure the at least one processor to:
compute a similarity score using cosine similarity or Euclidean distance.

4. The computer system of claim 3, wherein the instructions, when executed by the at least one processor, further configure the at least one processor to:
apply a similarity threshold to filter the stored query vectors in the query index based on the similarity score.

5. The computer system of claim 1, wherein the instructions, when executed by the at least one processor, further configure the at least one processor to:
retrieve a predefined number of top-ranked stored query vectors, each associated with a corresponding document section.

6. The computer system of claim 1, wherein each stored query vector is stored in association with at least one corresponding document section in the query index.

7. The computer system of claim 1, wherein the instructions, when executed by the at least one processor, further configure the at least one processor to:
provide the query and the retrieved at least one document section and as input to a large language model to generate a natural language response to the query.

8. The computer system of claim 7, wherein the instructions, when executed by the at least one processor, further configure the at least one processor to:
output the generated natural language response via a user interface displayed on a computing device.

9. The computer system of claim 1, wherein the instructions, when executed by the at least one processor, further configure the at least one processor to:
select a prompt template based on one or more characteristics of the retrieved at least one document section; and
provide the selected prompt template together with the retrieved at least one document section and the query as input to a large language model to generate a natural language response to the query.

10. The computer system of claim 9, wherein the instructions, when executed by the at least one processor, further configure the at least one processor to:
output the generated natural language response via a user interface displayed on a computing device.

11. A computer-implemented method comprising:
receiving a query;
embedding the query into a query vector;
comparing the query vector to stored query vectors in a query index to identify at least one similar query; and
retrieving at least one document section associated with the at least one similar query.

12. The computer-implemented method of claim 11, wherein the stored query vectors include synthetic query vectors.

13. The computer-implemented method of claim 11, wherein comparing the query vector to the stored query vectors in the query index comprises computing a similarity score using cosine similarity or Euclidean distance.

14. The computer-implemented method of claim 13, further comprising:
applying a similarity threshold to filter the stored query vectors in the query index based on similarity score.

15. The computer-implemented method of claim 11, further comprising:
retrieving a predefined number of top-ranked stored query vectors, each associated with a corresponding document section.

16. The computer-implemented method of claim 11, wherein each stored query vector is stored in association with at least one corresponding document section in the query index.

17. The computer-implemented method of claim 11, further comprising:
providing the retrieved at least one document section and the query as input to a large language model to generate a natural language response to the query.

18. The computer-implemented method of claim 17, further comprising:
outputting the generated natural language response via a user interface displayed on a computing device.

19. The computer-implemented method of claim 11, further comprising:
selecting a prompt template based on one or more characteristics of the retrieved at least one document section;
providing the selected prompt template together with the retrieved at least one document section and the query as input to a large language model to generate a natural language response to the query; and
outputting the generated natural language response via a user interface displayed on a computing device.

20. A non-transitory computer readable storage medium comprising computer-executable instructions which, when executed, configure at least one processor to:
receive a query;
embed the query into a query vector;
compare the query vector to stored query vectors in a query index to identify at least one similar query; and
retrieve at least one document section associated with the at least one similar query.
